(19) United States
(12) Patent Application Publication
(10) Pub. No.: US 2011/0036269 A1
(43) Pub. Date: Feb. 17, 2011

(54) INDIUM TIN OXIDE POWDER AND DISPERSION THEREOF

(75) Inventors: Sven Hill, Aschaffenburg (DE); Willibald Wombacher, Johannesberg (DE); Katharina Dauth, Offenbach (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/988,440

(22) PCT Filed: Apr. 16, 2009
(86) PCT No.: PCT/EP2009/054510

§ 371 Date: Oct. 18, 2010

(30) Foreign Application Priority Data
May 6, 2008 (EP) 08103837.4

(51) Int. Cl. C09D 1/00; C01G 15/00

(52) U.S. Cl. 106/287.19; 423/594.9

(57) ABSTRACT

Surface-modified agglomerate of indium tin oxohydrate with a proportion of indium of 80 to 98.9% by weight, of tin of 2 to 20% by weight and of carbon of 0.01 to 1% by weight. Process for preparing a surface-modified agglomerate of indium tin oxide, in which the surface-modified agglomerate of indium tin oxohydrate is dried under air at temperatures of more than 150° C. and less than 310° C., and is then calcined under reducing conditions. Surface-modified agglomerate of indium tin oxide obtainable by this process. Process for preparing a surface-modified powder of indium tin oxide and a dispersion thereof, in which the surface-modified agglomerate and one or more solvents are combined to give a mixture, the mixture is converted to a dispersion by means of a dispersing unit and liquid constituents are optionally removed from the dispersion in order to obtain a powder. Process for producing a coating material or moulding material, in which the agglomerates of indium tin oxide or the dispersion of indium tin oxide powder and in each case one or more binders are used.

The invention relates to a surface-modified agglomerate of indium tin oxohydrate and to the preparation thereof.

The invention further relates to a process for preparing a surface-modified agglomerate of indium tin oxide, and to the surface-modified agglomerate of indium tin oxide (ITO) itself.

The invention further relates to a process for preparing a surface-modified powder of indium tin oxide (ITO) and a dispersion thereof, and to the powder and to the dispersion itself.

The invention further relates to a process for producing coating and moulding materials using the surface-modified agglomerates of indium tin oxide or of the surface-modified powder of indium tin oxide.

Indium tin oxide layers are notable for high transparency, high electrical conductivity and high IR absorption capacity. Such layers can be obtained, for example, by sputtering methods or by applying indium tin oxide powder in the form of dispersions.

For the preparation of indium tin oxide powder, various methods are known: (co)precipitation methods, hydrothermal methods, sol-gel methods, plasma methods or pyrogenic methods.

U.S. Pat. No. 5,818,810 discloses an ITO powder which, on the xy colour scale, has x values of 0.220 to 0.295 and y values of 0.235 to 0.352, and which has a lattice constant of 10.110 to 10.160 angstrom. It can be obtained by precipitating a solution containing tin and indium compounds in the presence of ammonium carbonate, removing and drying the precipitate and calcining at temperatures of 450 to 750° C. in a reducing atmosphere.

DE-A-19650747 describes an ITO powder with a particle size of 0.05 to 1 μm and a halogen content of less than 0.2% by weight. It can be obtained by adjusting the pH of a solution of indium and tin salts with alkali to pH values of 4 to 6, removing and drying the precipitate formed, and calcining at temperatures of 600 to 1200° C., optionally in a reducing atmosphere. A disadvantage of this powder is the low transparency of coated substrates.

EP-A-921099 discloses a process which comprises the neutralization of a solution containing indium salt and tin salt with ammonia, removal and drying of the precipitate and subsequent calcination, first under air at 550 to 700° C., then under reducing conditions at 350 to 450° C. The ITO powder thus obtained has a corundum crystal structure with a density of not less than 6.5 g·cm⁻³, a green density of not less than 3.0 g·cm⁻³ and a Seebeck coefficient of less than 30 μV·cm⁻³ at 20° C. and less than 80 μV·cm⁻³ after heating to 200° C. What is essential in the preparation of the powder is the maintenance of the pH within the range of 6.8 to 7.5 and a temperature of 350 to 450° C. in the calcination.

WO0014017 discloses a process for preparing suspensions and powders based on a surface-modified ITO, in which indium and tin compounds are coprecipitated in the presence of surface-modifying components, the solvent is removed from the resulting powder which is then calcined, the calcination is followed by addition of one or more surface-modifying components and one or more solvents, the resulting mixture is subjected to a comminution or dispersion treatment to form a dispersion, and any liquid components are removed from the suspension in order to obtain a powder. The surface-modifying components used may be mono- or polycarboxylic acids, diketones, amino acids, polyethylene oxide derivatives, amines or acid amides, or mixtures of two or more of these components.

WO2004/000594 discloses a process for preparing an ITO powder, in which the product obtained by means of a coprecipitation process in which soluble indium and tin components are precipitated by increasing the pH is dried, converted to the crystalline phase by treatment at 300° C. under a normal air atmosphere and then subjected to further heat treatment at 300° C. under forming gas. The resulting ITO powders have, on the xy colour scale, values of x=0.294 to 0.414 and y values of y=0.332 to 0.421.

The known coprecipitation processes lead to products which have defects with regard to transparency, electrical conductivity and IR absorption capacity. It was therefore an object of the present invention to provide a process which leads to an ITO powder with better properties.

### DEFINITIONS

According to the invention, an agglomerate is understood to mean primary particles held together by cohesion. The resulting three-dimensional structures can be handled as such, and fall apart under the action of shearing energy to give primary particles isolated from one another. It is additionally possible that the agglomerates according to the invention also contain a small proportion, less than 8%, generally less than 5%, of primary particles bonded firmly to one another. The number of firmly bonded primary particles is generally 2 to 10. According to the invention, the agglomerates can be obtained by spray-drying. An agglomerate usually has a mean agglomerate diameter of 5 to 50 μm.

According to the invention, primary particles isolated fully or very substantially fully from one another are understood to mean a powder. If primary particles bonded firmly to one another are present, the number of primary particles bonded firmly to one another is generally restricted to 2 to 10. The mean primary particle diameter may be 2 to 50 nm. According to the invention, the powder can be obtained from an agglomerate by the action of shear forces.

An indium tin oxohydrate is essentially understood to mean X-ray-amorphous particles. The oxohydrate may contain small proportions of crystalline compounds. The indium tin oxohydrate of the present invention can be converted by a specified thermal treatment to an indium tin oxide which consists predominantly or completely of cubic indium tin oxide.

According to the invention, the indium tin oxide is essentially a mixed oxide of indium and tin. Indium and tin may be present therein in one oxidation state or in different oxidation states. For example, In(+I) and/or In(+III) and Sn(+II) and/or Sn(+IV) are present. Sn is preferably present in the form of Sn(+IV). Indium and tin may optionally also be present partly as In(0) or Sn(0).

The indium tin oxide is a tin-doped indium oxide, i.e. the proportion of tin oxide is lower than the proportion of indium oxide. The proportion of tin, based on the sum of indium, calculated as In, and tin, calculated as Sn, is, for example, 2 to 20% by weight. The indium tin oxide of the present invention has, as the crystalline phase, predominantly or entirely cubic indium tin oxide.

According to the invention, the indium tin oxohydrate and the indium tin oxide may contain impurities. The acceptable degree depends on the end use. Through the reactants, for example, SO₄² , Co, Cu, Fe, Ni, Pb, Zn, K or Na may be present. Through use of pure reactants, SO₄²⁻, Ca, Co, Cu, Fe, Ni, Pb and Zn can be brought to below 0.005% by weight, and Na, K to below 0.01% by weight. Compounds introduced via the process, for example NH₄⁻ and Cl⁻, can be removed virtually fully if required.

In general, less than 1% by weight of impurities based on the surface-modified indium tin oxohydrate and indium tin oxide is present.

Surface modification is understood to mean that organic molecules and/or fragments of such molecules, which generally have not more than a total of 24, especially not more than a total of 18 and more preferably not more than 12 carbon atoms, are bonded to the partial surface via a covalent or ionic bond and/or polar (dipole-dipole interaction) or van der Waals forces. Fragments may arise, for example, through a partial thermal degradation of the organic molecules. In the present invention, the surface modification is expressed by the proportion of carbon.

The invention firstly provides a surface-modified agglomerate of indium tin oxohydrate with a proportion of
indium, calculated as In, of 80 to 98.9% by weight, preferably 90 to 96% by weight,
tin, calculated as Sn, of 2 to 20% by weight, preferably 4 to 10% by weight,
carbon of 0.01 to 1% by weight, preferably 0.01 to 0.1% by weight,
where the sum of these proportions is at least 99% by weight based on the sum of indium, tin and carbon.

The agglomerates have a mean aggregate diameter of 5 to 50 μm, preferably 10 to 20 μm, and can be divided predominantly or fully into primary particles by simple dispersion.

The BET surface area of the agglomerates of indium tin oxohydrate is preferably 50 to 200 m²/g and more preferably 80 to 140 m²/g.

The invention further provides a process for preparing the surface-modified agglomerate, in which
a) an aqueous solution containing indium and tin compounds and one or more surface-modifying components, adjusted to a pH of 3.5 to 4.5, is removed from dissolved reaction products and unconverted feedstocks of the reaction mixture, and
b) the resulting dispersion is subjected to spray-drying.

Suitable indium compounds are indium chloride, indium iodide, indium nitrate, indium acetate, indium sulphate, indium alkoxides such as indium methoxide or indium ethoxide, or mixtures thereof, where indium is present in the +3 oxidation state or else in the +1 oxidation state in the chloride and iodide.

Suitable tin compounds are tin chloride, tin sulphate, tin alkoxides such as tin methoxide or tin ethoxide, or mixtures thereof, where tin is present in the +2 or +4 oxidation state.

It is possible with preference to use mixtures of indium trichloride (InCl₃) and tin chloride (SnCl₂).

Suitable surface-modifying components are
saturated or unsaturated mono- and polycarboxylic acids (preferably monocarboxylic acids) having 1 to 24 carbon atoms, for example formic acid, acetic acid, propionic acid, butyric acid, pentanoic acid, hexanoic acid, acrylic acid, methacrylic acid, crotonic acid, citric acid, adipic acid, succinic acid, glutaric acid, oxalic acid, maleic acid, fumaric acid, itaconic acid, stearic acid and especially 3,6,9-trioxadecanoic acid, and the corresponding anhydrides;
mono- and polyamines, especially those of the general formula R₃₋ₙNHₙ in which n=0, 1 or 2 and the R radicals are each independently alkyl groups having 1 to 12, especially 1 to 6 and more preferably 1 to 4 carbon atoms, for example methyl, ethyl, n- and i-propyl and butyl; polyethyleneamines;
acid amides, especially caprolactam;
amino acids, especially β-alanine, glycine, valine, aminocaproic acid, leucine and isoleucine;
dicarbonyl compounds having 4 to 12, especially 5 to 8, carbon atoms, for example acetylacetone, 2,4-hexanedione, 3,5-heptanedione, acetoacetic acid, C₁-C₄-alkyl acetoacetates such as ethyl acetoacetate, diacetyl and acetonylacetone;
surfactants, for example cationic, anionic, nonionic and amphoteric surfactants. Preference is given to nonionic surfactants, particular preference being given to polyethylene oxide derivatives. These may be derivatives with saturated or unsaturated (mono)carboxylic acids, especially with carboxylic acids having more than 7, preferably more than 11, carbon atoms, for example polyethylene oxide derivatives with stearic acid, palmitic acid or oleic acid. They may also be derivatives with sorbitan esters, in which case useful carboxylic acids include, for example, those mentioned above. In addition, it is possible to use polyethylene oxide (mono)alkyl ethers, for example with alcohols having more than 7, preferably more than 11, carbon atoms.

The surface-modifying components can be used individually or as a mixture. Particularly preferred compounds are 3,6,9-trioxadecanoic acid, β-alanine and caprolactam.

The proportion of the surface-modifying component used is, based on the sum of the indium and tin compound used, preferably 2 to 30% by weight, more preferably 2 to 6% by weight.

The pH in the range from 3.5 to 4.5 can be established, for example, by means of primary, secondary, tertiary, aliphatic or aromatic amines, tetramethylammonium hydroxide, NaOH, KOH, ammonia, ammonium hydroxide or mixtures thereof. Particular preference is given to using ammonium hydroxide. It has been found to be advantageous to leave the reaction mixture within this pH range for 1 to 24 hours. Subsequently, it is advantageous to establish a pH of 9 to 9.5. This can be done by means of the same compounds which have also been used in the adjustment to the pH range of 3.5 to 4.5.

Advantageously, the salts obtained in the reaction are removed from the reaction mixture. For this purpose, especially for the removal of ammonium salts, a crossflow filtration has been found to be useful, which can be carried out in such a way that the conductivity of the dispersion is preferably less than 5000 μS/cm, preferably less than 2000 μS/cm.

Subsequently, the reaction mixture can be concentrated, for example, by evaporation.

The solids content of the dispersion which is supplied to the spray-drying step is preferably 10 to 50% by weight, based on the dispersion.

The spray-drying is preferably carried out at temperatures of 100 to 150° C.

The invention further provides a process for preparing a surface-modified agglomerate of indium tin oxide, in which the inventive surface-modified agglomerate of indium tin oxohydrate is dried under air at temperatures of more than 150° C. and less than 310° C. and is then calcined under reducing conditions.

The best results are obtained when a two-stage calcination is carried out, in which the second calcination step is carried out at a higher temperature than the first. The two-stage calcination comprises the steps of
treatment at temperatures of 240° C. to 260° C. under reducing conditions,
cooling to room temperature and storage under air, then
treatment at temperatures of 270° C. to 310° C. under reducing conditions.

The individual treatment steps can be carried out over a period of in each case 0.5 to 8 hours.

The invention further provides a surface-modified agglomerate of indium tin oxide obtainable by the process according to the invention.

The agglomerates have a mean aggregate diameter of 5 to 50 μm, preferably 10 to 25 μm, and can be divided predominantly or fully into primary particles by simple dispersion.

The BET surface area of the agglomerates of indium tin oxide is less than the BET surface area of the agglomerates of the indium tin oxohydrate from which they are obtained. The BET surface area is preferably 30 to 100 m²/g and more preferably 40 to 80 m²/g.

The crystalline constituents consist predominantly or fully of cubic indium tin oxide. In addition, the inventive agglomerates have a carbon content of 0.01 to <1% by weight, preferably 0.01 to <0.1% by weight and more preferably 0.02 to 0.08% by weight. The carbon content of the agglomerates obtained after the calcination is lower than the carbon content of the agglomerates obtained after the spray-drying. It is additionally assumed that the chemical composition of the surface modification is different after the calcination and the spray-drying.

The invention further provides a process for preparing a surface-modified powder of indium tin oxide and a dispersion thereof, in which the inventive surface-modified agglomerate of indium tin oxide and one or more solvents are combined to give a mixture, the mixture is converted to a dispersion by means of a dispersing unit and liquid constituents are optionally removed from the dispersion in order to obtain a powder.

Suitable dispersing units may be mills, kneaders, roll mills, high-energy mills in which two or more predispersion streams collide with one another at pressures of 1000 to 4000 bar. In particular, it is possible to use planetary ball mills, stirred ball mills, mortar mills and three-roll mills. Dispersion by means of ultrasound is likewise suitable.

The dispersion is carried out with addition of one or more solvents. Suitable solvents may be
water;
alcohols, for example methanol, ethanol, n- and i-propanol and butanol;
glycols and glycol ethers, for example ethylene glycol, propylene glycol or butylene glycol, the corresponding di-, tri-, tetra-, penta- or hexamers, and the corresponding mono- or diethers, where one or both hydroxyl groups are replaced by, for example, a methoxy, ethoxy, propoxy or butoxy group;
ketones, for example acetone and butanone;
esters, for example ethyl acetate;
ethers, for example diethyl ether, tetrahydrofuran and tetrahydropyran;
amides, for example dimethylacetamide and dimethylformamide;
sulphoxides and sulphones, for example sulpholane and dimethyl sulphoxide;
aliphatic (optionally halogenated) hydrocarbons, for example pentane, hexane and cyclohexane;
polyols, for example 2-methyl-2,4-pentanediol;
polyethylene glycols and ethers thereof, such as diethylene glycol, triethylene glycol, tetraethylene glycol, diethylene glycol diethyl ether, tetraethylene glycol dimethyl ether or diethylene glycol monobutyl ether;
ethylene glycol, diethylene glycol and diethylene glycol monobutyl ether are used with preference.

It is also possible to use mixtures of such solvents.

For the dispersion, it is possible with preference to use solvents whose evaporation number is preferably 100 or more, more preferably 100 to 200. This allows solvent losses during the dispersion step to be avoided. After the dispersion step, it is then possible to dilute with further solvents whose evaporation number is less than 100, preferably 10 to 50. The evaporation number is based on diethyl ether, whose evaporation number is 1.

The proportion of the solvent with the evaporation number of 100 or more is preferably 10 to 80% by weight, more preferably 15 to 60% by weight, based on the sum of the proportions by weight of indium tin oxide and solvent with an evaporation number of 100 or more.

The proportion of the surface-modified agglomerates of indium tin oxide used is preferably 20 to 50% by weight. It has been found that it is especially possible to use surface-modified agglomerates of indium tin oxide which have been precipitated in the presence of caprolactam. The use of these agglomerates leads to an indium tin oxide powder or a dispersion thereof which has a particularly high conductivity.

The dispersion can additionally also be effected in the presence of one or more surface-modifying compounds. These may be the same which have also already been used in the precipitation. It is possible with preference to use organic carboxylic acids, anhydrides or acid amides. It is possible with particular preference to use 3,6,9-trioxadecanoic acid.

The invention further provides a dispersion comprising a surface-modified indium tin oxide powder and the surface-modified indium tin oxide powder itself, both obtainable by the process according to the invention.

The BET surface area of the indium tin oxide powder is essentially the same as that of the agglomerates of indium tin oxide. No reduction in the BET surface area as a result of the dispersion treatment is observed.

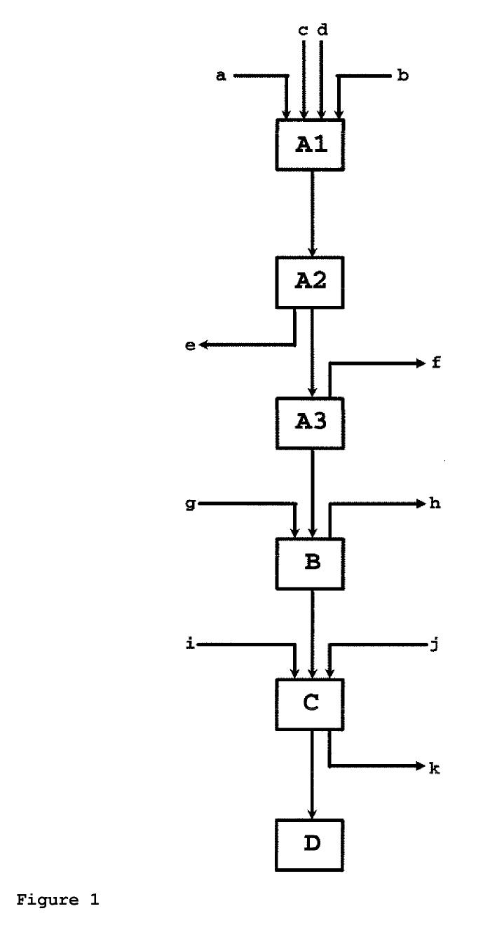

FIG. 1 shows a schematic flow diagram for a preferred embodiment comprising the process steps of

A1=precipitation

A2=crossflow filtration

A3=spray-drying

B=drying and calcination

C=dispersion preparation

D=removal of ITO powder and the feedstocks and reaction products comprising

a=indium chloride

b=tin chloride

c=caprolactam

d=ammonium hydroxide

e=ammonium chloride

f=predominantly water

g=forming gas

h=offgas

i=solvent

j=3,6,9-trioxadecanoic acid (optional)

k=liquid phase.

The invention further provides a process for preparing a coating material or moulding material, in which the inventive agglomerates of indium tin oxide and/or the inventive dispersion of indium tin oxide powder and in each case one or more binders are used.

The proportion of binder, based on the dried coating material or moulding material, is preferably 10 to 91% by weight and more preferably 40 to 85% by weight.

Dried coating material or moulding material is understood to mean the material without volatile constituents. The drying is effected generally at temperatures of 20 to 150° C.

The binders used may be inorganic and organic binders. Suitable binders are, for example, polyvinyl resins, polyolefins, PVC, polyvinyl alcohol, polyvinyl esters, polystyrene, acrylic resins, acrylic esters, alkyd resins, polyurethane coating materials, urea resins, melamine resins, phenol resin coating materials. It is possible with preference to use cellulose, methylcellulose, hydroxypropylcellulose, nitrocellulose and cellulose esters.

The coating material or moulding material may additionally also comprise nanoscale inorganic solid particles (nanoparticles). The usable nanoparticles preferably have a mean particle diameter of not more than 200 nm, preferably of not more than 100 nm. It is possible with preference to use nanoscale metal oxide particles, for example aluminium oxide, cadmium oxide, cerium oxide, iron oxide, copper oxide, molybdenum oxide, niobium oxide, silicon dioxide, tantalum oxide, titanium dioxide, vanadium oxide, tungsten oxide, zinc oxide, tin oxide, zirconium oxide and mixed oxides of the aforementioned metal oxides. The nanoscale particles may additionally be present in the form of phosphates, silicates, zirconates, aluminates, stannates.

The application can be effected, for example, by printing, spin/dip-coating, knife coating, dipping, spraying (inkjet).

The invention further provides a coating material or moulding material with a surface resistivity of less than 1000 Ohm/Π, which is obtainable by the process according to the invention. The ITO content in the coating material may preferably be 60 to 85% by weight.

The coating materials and moulding materials may find use in opto- and microelectronics, for optically transparent, IR-blocking or conductive coatings. In addition, they may be part of screenprinting pastes, liquid-crystal displays, electroluminescent displays, electrochromic displays, transparent conductive layers.

### EXAMPLES

A) Agglomerates of Surface-Modified Indium Tin Oxohydrates

### Example A-1

151.1 kg of indium(III) chloride, 12.6 kg of tin(IV) chloride·5 H₂O and 6.25 kg of caprolactam are added to 460.4 kg of water and stirred. Once a clear solution has formed, it is heated to 50° C. Subsequently, 122.8 kg of ammonium hydroxide solution (25%) are added dropwise with stirring. The suspension is stirred for a further 24 hours. Subsequently, another 208.52 kg of ammonium hydroxide solution are added. Ammonium chloride is removed by crossflow filtration: permeate flow 260-300 kg/m²h. The conductivity of the suspension is 1018 μS/cm. Subsequently, the liquid phase is removed by spray-drying. To this end, 20 l/h of the suspension obtained after the removal of ammonium chloride with a solids content of 9.6% by weight are atomized with the aid of 8 m³ (STP)/h of air into a dryer (operating temperature 300° C., cone temperature 110° C., output air temperature 115° C.). Agglomerates of indium tin oxohydrate with the physicochemical values shown in Table 1 are obtained.

### Example A-2

Analogous to Example 1, except using 147.8 kg of indium(III) chloride, 176.4 kg of tin(IV) chloride·5 H₂O and 6.25 kg of caprolactam.

### Example A-3

Analogous to Example 1, except using 151.1 kg of indium(III) chloride, 12.6 kg of tin(IV) chloride·5 H₂O and 6.25 kg of β-alanine.

Agglomerates of indium tin oxohydrate with the physicochemical values shown in Table 1 are obtained.

TABLE 1
Agglomerates of indium tin oxohydrate

| Example | | A-1 | A-2 | A-3 |
|---|---|---|---|---|
| In content | % by wt. | 94.96 | 92.17 | 94.96 |
| Sn content | % by wt. | 4.99 | 6.94 | 4.98 |
| C content | % by wt. | 0.042 | 0.089 | 0.056 |
| BET surface area¹⁾ | m²/g | 121 | 127 | 117 |
| Tamped density²⁾ | g/l | 684 | n.d. | n.d. |
| Drying loss³⁾ | % by wt. | 4.4 | n.d. | n.d. |
| Ignition loss⁴⁾ | % by wt. | 18.0 | n.d. | n.d |
| d₅₀⁵⁾ | μm | 12.8 | 17.9 | 16.5 |
| pH⁶⁾ | | 5.4 | n.d. | n.d. |

¹⁾to DIN 66131;
²⁾based on DIN EN ISO 787/11, August 1983;
³⁾2 h at 105° C.;
⁴⁾2 hours at 1000° C.;
⁵⁾Cilas d₅₀ value;
⁶⁾4 percent dispersion in water

B) Agglomerates of Surface-Modified Indium Tin Oxide

### Example B1a

The agglomerates from Example A1 are first dried under air at 300° C. over a period of 1 h and then kept in a forming gas atmosphere in an oven at a temperature of 300° C. over a period of 1 h.

### Example B-1b

The agglomerates from Example A1 are first dried under air at 300° C. over a period of 1 h and then kept in a forming gas atmosphere in an oven at a temperature of 250° C. over a period of 1 h. After cooling to room temperature, the solid is stored under air at room temperature over a period of 8 h and then kept in a forming gas atmosphere at a temperature of 275° C. over a period of 1 h.

### Example B2

Procedure analogous to Example B-1b, except using the agglomerates from Example A2.

The physicochemical values of the agglomerates of indium tin oxide obtained from Examples B-1a, B-1b and B-2 are shown in Table 2.

TABLE 2
Agglomerates of indium tin oxide

| Example | | B-1a | B-1b | B-2 |
|---|---|---|---|---|
| In content | % by wt. | 94.98 | 94.98 | 94.98 |
| Sn content | % by wt. | 4.99 | 4.99 | 4.99 |
| C content | % by wt. | 0.029 | 0.025 | 0.016 |
| Crystal phase | | Cubic In₂O₃ | | |
| BET surface area | m²/g | 45 | 68 | 78 |
| Powder conductivity | Ohm · cm | 3 | 1 | 1.2 |
| Tamped density | g/l | 982 | 1035 | 1075 |
| Drying loss | % by wt. | 0.91 | 0.73 | 0.32 |
| Ignition loss | % by wt. | 0.94 | 1.00 | 0.94 |
| d₅₀ | μm | 47 | 19 | 23 |
| pH | | 3.6 | 4.1 | 3.9 |
| x/y colour values | | 0.306/ | 0.309/ | 0.308/ |
| | | 0.348 | 0.339 | 0.350 |

C) Dispersion of Surface-Modified Indium Tin Oxide Particles

### Example C-1b-a

100 g of the agglomerates of indium tin oxide from Example B-1b are suspended in 48 g of ethylene glycol and ground on a three-roll mill over a period of 20 min. The agglomerates are easy to divide. The surface-modified indium tin oxide particles have a d₅₀ value determined by means of laser diffraction in a 1% dispersion of 60 nm and a d₉₀ value of 105 nm.

### Example C-1b-b

100 g of the agglomerates of indium tin oxide from Example B-1b are suspended in 34 g of Dowanol PPH and 3.1 g of 3,6,9-trioxadecanoic acid and ground on a three-roll mill over a period of 20 min. The surface-modified indium tin oxide particles have a d₅₀ value determined by means of laser diffraction in a 1% dispersion of 65 nm and a d₉₀ value of 108 nm.

### Example C-2-b

Analogous to Example C-1b-b, except using agglomerates of indium tin oxide from Example B-2. The surface-modified indium tin oxide particles have a d₅₀ value determined by means of laser diffraction in a 1% dispersion of 65 nm and a d₉₀ value of 110 nm.

### Example C-1b-c

40.00 g of the agglomerates of indium tin oxide from Example B-1b are suspended in a mixture of 49.04 g of diacetone alcohol, 10.00 g of butylethoxyethyl acetate and 0.96 g of 3,6,9-trioxadecanoic acid, and ground on a three-roll mill over a period of 20 min.

### Example C-2-c

Analogous to Example C-1b-c, except using the agglomerates of indium tin oxide from Example B-2.

D) Coating Materials

### Example D-1b-c

The coating material is obtained by mixing equal proportions in terms of weight of the dispersion from Example C-1b-c with a solution of 17 parts by weight of nitrocellulose and 83 parts by weight of diacetone alcohol.

### Example D-2-c

Analogous to Example D-1b-c, except using the dispersion from Example C-2-c.

### Comparative Example

Analogous to Example D-1b-c, except using a dispersion which contains an indium tin oxide powder disclosed in EP-A-1113992, Example 1b, after forming. Analogously to Example C-1b-c, a dispersion is prepared using this powder.

The coating materials from Examples D-1b-c and D-2-b, and from the comparative example, are applied to glass and PET and cured at 120° C. for 1 h. The ITO content in the liquid coating material is in each case 28% by weight, and 82.5% by weight in the solid coating material. The proportion of binder in the liquid coating material is in each case 6% by weight, and 17.5% by weight in the solid coating material. The wet film thickness is in each case 50 μm, the dry film thickness 5.1 μm.

TABLE 3
Surface resistivities on glass and PET

| | | According to invention | | | | | |
|---|---|---|---|---|---|---|---|
| Example | | D-1b-c | | D-2-c | | Comparative | |
| Substrate | | Glass | PET | Glass | PET | Glass | PET |
| Resistivity | Ohm/□ | 394 | 460 | 750 | 780 | 1900 | 2255 |

The coated substrates produced with the inventive agglomerates of indium tin oxide have a significantly lower surface resistivity than those substrates which have been coated with indium tin oxide according to the prior art.

1. A surface-modified agglomerate of indium tin oxohydrate, comprising a proportion of:
(A) indium, calculated as In, of 80 to 98.9% by weight;
(B) tin, calculated as Sn, of 2 to 20% by weight; and
(C) carbon of 0.01 to 1% by weight,
wherein a sum of proportions (A), (B), and (C) is at least 99% by weight based on a sum of metals, in any ionic state, and carbon present.

2. A process for preparing the surface-modified agglomerate according to claim 1, comprising
a) adjusting a pH of an aqueous solution comprising indium and tin compounds and at least one surface-modifying component in a reaction mixture, to 3.5 to 4.5, and removing a resulting dispersion from dissolved reaction products and unconverted feedstocks of the reaction mixture, and
b) spray-drying the resulting dispersion.

3. A process for preparing a surface-modified agglomerate of indium tin oxide, the process comprising
drying the surface-modified agglomerate of indium tin oxohydrate according to claim 1 under air at temperatures of more than 150° C. and less than 310° C_{S} and then calcining the agglomerate under reducing conditions.

4. The process according to claim 3, wherein the calcining comprises:
(A) first, heating the agglomerate at temperatures of 240° C. to 260° C. under reducing conditions; then
(B) cooling the agglomerate to room temperature, stored under air; and then
(C) heating the agglomerate at temperatures of 270° C. to 310° C. under reducing conditions.

5. A surface-modified agglomerate of indium tin oxide obtained by the process according to claim 3.

6. A process for preparing a surface-modified powder of indium tin oxide and a dispersion thereof, the process comprising:
combining the surface-modified agglomerate according to claim 5 and at least one solvent to give a mixture;
converting the mixture to a dispersion with a dispersing unit; and
optionally, removing liquid constituents from the dispersion to obtain a powder.

7. The process according to claim 6, wherein the surface-modified agglomerate is obtained by treatment with at least one surface-modifying component.

8. A dispersion comprising surface-modified indium tin oxide powder obtained by the process according to claim 6.

9. A surface-modified indium tin oxide powder obtained by the process according to claim 6.

10. A process for producing a coating material or molding material, the process comprising combining the agglomerate of indium tin oxide according to claim 5 with at least one binder.

11. A coating material or molding material with a surface resistivity of less than 1000 Ohm/□ obtained by the process according to claim 10.

12. A surface-modified agglomerate of indium tin oxide obtained by the process according to claim 4.

13. A process for preparing a surface-modified powder of indium tin oxide and a dispersion thereof, the process comprising:
combining the surface-modified agglomerate according to claim 12 and at least one solvent to give a mixture;
converting the mixture to a dispersion with a dispersing unit; and
optionally, removing liquid constituents from the dispersion to obtain a powder.

14. The process according to claim 13, wherein the surface-modified agglomerate is obtained by treatment with at least one surface-modifying component.

15. A dispersion comprising surface-modified indium tin oxide powder obtained by the process according to claim 13.

16. A dispersion comprising surface-modified indium tin oxide powder obtained by the process according to claim 14.

17. A surface-modified indium tin oxide powder obtained by the process according to claim 13.

18. A surface-modified indium tin oxide powder obtained by the process according to claim 14.

19. A process for producing a coating material or molding material, the process comprising combining the agglomerate of indium tin oxide according to claim 12 with at least one binder.

20. A process for producing a coating material or molding material, the process comprising combining the dispersion comprising indium tin oxide powder according to claim 8 with at least one binder.
